(19) United States
(12) Patent Application Publication
(10) Pub. No.: US 2003/0128639 A1
(43) Pub. Date: Jul. 10, 2003

(54) Optical disc device

(75) Inventors: Jun Kikuchi, Takatsuki-shi (JP); Fumihiro Itoh, Yawata-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Kadoma-shi (JP)

(21) Appl. No.: 10/320,736

(22) Filed: Dec. 17, 2002

(30) Foreign Application Priority Data
Dec. 18, 2001 (JP) 2001-384060

(51) Int. Cl. G11B 7/095

(52) U.S. Cl. 369/44.29

(57) ABSTRACT

The present invention provides an optical disc device capable of performing appropriate adjustment of an off-track level. The optical disc device comprises an envelope signal generation unit 104 for generating an envelope signal on the basis of a RF signal from an optical pickup; an off-track signal generation unit 105 for binarizing the envelope signal with the off-track level as a slice level to generate an off-track signal; an off-track measurement unit 106 for measuring high level periods and low level periods of the off-track signal; and an off-track level adjustment unit 109 for adjusting the off-track level which is set on the off-track signal generation unit 105, on the basis of the ratio between the high level periods and the low level periods.

### TECHNICAL FIELD OF THE INVENTION

The present invention relates to an optical disc device and, more particularly, to that for generating an off-track signal from an envelope signal of a RF signal.

### BACKGROUND ART

FIG. 19 is a block diagram illustrating the construction of a conventional optical disc device. Further, FIG. 20 is a diagram illustrating a block which performs generation of an OFTR signal.

With reference to FIG. 19, the conventional optical disc device is provided with a disc motor 102 for rotating an optical disc 101 in which data are recorded on tracks; an optical pickup 103 for irradiating the optical disc 101 with laser light, and receiving the reflected light to generate a RF signal; an envelope signal generation unit 104 for generating an envelope signal (RFENV signal) on the basis of the RF signal; an off-track signal generation unit 201 for comparing the envelope signal with an off-track level signal (OFTRL signal) of a predetermined level which is generated by an off-track level generation unit (not shown in FIG. 19) 202 shown in FIG. 20, and generating an off-track signal (OFTR signal) by binarizing the envelope signal using the off-track level signal as a slice level; a servo control unit 112 for performing tracking servo control in the optical pickup 103 and traverse servo control of the optical pickup 103 on the basis of the off-track signal; and a traverse driving unit 108 for traverse-driving the optical pickup 103 according to a traverse driving signal supplied from the servo control unit 112.

The optical pickup 103 has a tracking actuator 107 for driving an objective lens (not shown) that is possessed by the optical pickup 103, in the tracking direction (the direction of the radius of the optical disc 101), according to a tracking actuator driving signal supplied from the servo control unit 112. The off-track signal generated by the off-track signal generation unit 201 indicates the off-track state where the beam spot of laser light on the optical disc 101 is outside the tracks. That is, a change of the off-track signal between the high level and the low level indicates that the beam spot crosses a track.

FIG. 21 is a diagram for explaining a manner of generating an off-track signal from a RF signal.

FIG. 21(a) shows a case where an off-track signal is generated with an appropriate off-track level. That is, since the appropriate off-track level is used, the off-track state is normally indicated by the off-track signal.

However, there might be a case where an appropriate off-track signal cannot be generated, depending on the value of the off-track level.

FIG. 21(b) shows a case where an off-track signal is generated using the same off-track level signal as used in FIG. 21(a) when the amount of reflected light from the optical disc 101 is small. That is, since the value of the off-track level signal is too high with respect to the RF signal in this case, an appropriate off-track signal cannot be generated, and the off-track state is not normally indicated by the off-track signal.

The off-track signal is a signal used for measuring the number of tracks over which the beam spot crosses at seeking or for holding a PLL at off-track, and therefore, it is desired to accurately indicate the off-track state of the beam spot of the laser light.

On the other hand, the amplitudes or DC levels of the RF signal and the RFENV signal vary under the influences of the laser characteristics, the amount of reflected light from the optical disc, the track pitch, and the like. Since the amount of reflected light, the track pitch, and the available laser vary among the media used by the optical disc device, i.e., the optical discs, the off-track level signal as a slice level for generating an off-track signal is a set value unique to each optical disc. However, when performing recording/playback by using an optical disc which is out of media specs or an optical disc with a blemish, since the amount of reflected light, the track pitch, and the like of the optical disc are different from those of optical discs in the normal states, an off-track signal cannot be appropriately generated. Thereby, an error occurs in measuring the number of cross tracks at seeking, resulting in an increase in access time or a reduction in readability.

### SUMMARY OF THE INVENTION

The present invention is made to solve the above-described problems and has for its object to provide an optical disc device that can generate an appropriate off-track signal which indicates a normal off-track state, and that can solve the problems such as an increase in access time and a reduction in readability.

An optical disc device according to the present invention comprises an optical pickup for applying a laser light to an optical disc which is rotated by a disc motor, and receiving the reflected light to generate a RF signal; an envelope signal generation unit for generating an envelope signal on the basis of the RF signal; an off-track signal generation unit for binarizing the envelope signal using an off-track level as a slice level to generate an off-track signal; an off-track measurement unit for measuring high level periods and low level periods of the off-track signal; and an off-track level adjustment unit for adjusting the off-track level which is set on the off-track signal generation unit, on the basis of the ratio between the high level periods of the off-track signal and the low level periods thereof. Therefore, an appropriate off-track signal can be generated by adjusting the off-track level as a slice level of the off-track signal, which has conventionally been set at a fixed value for each medium, to an appropriate level in accordance with the optical disc. By using this off-track signal, occurrence of errors in measuring the number of cross tracks at seeking can be avoided, thereby to avoid an increase in time required for access, a reduction in readability, and the like.

Further, the optical disc device according to the present invention further comprises a measurement result integration unit for integrating the high level periods of the off-track signal and the low level periods thereof, respectively, which periods are measured by the off-track measurement unit; and the off-track level adjustment unit performs adjustment of the off-track level on the basis of the ratio between the integrated high level period and the integrated low level period, which are obtained by the measurement result integration unit. Therefore, even when the respective high level periods and low level periods vary one by one, the high level periods and the low level periods are respectively integrated to be averaged, and the off-track level is adjusted by using the ratio of the integrated high level period to the integrated low level period, whereby more appropriate adjustment of the off-track level can be carried out.

Further, in the optical disc device according to the present invention, the off-track level adjustment unit performs adjustment of the off-track level in the state where the position of a beam spot of the laser light is fixed by performing no traverse servo control and no tracking servo control by a servo control unit while rotating the optical disc by the disc motor. Therefore, adjustment of the off-track level can be carried out without performing tracking servo control and traverse servo control.

Further, the optical disc device according to the present invention further comprises a rotation number measurement unit for measuring the number of rotations of the optical disc, and instructing the measurement result integration unit of a period during which the optical disc makes n rotations (n: integer equal to or larger than 1); and the measurement result integration unit performs integration during the period instructed from the rotation number measurement unit. Since the measurement result integration unit performs integration during a period equivalent to a predetermined number of rotations of the optical disc, the off-track level adjustment unit can adjust the off-track level by using the high level periods and the low level periods which are respectively averaged within the period equivalent to the predetermined number of rotations, whereby adjustment of the off-track level can be carried out without being affected by variations in the respective high level periods and low level periods.

Further, the optical disc device according to the present invention further comprises a measurement result selection unit for selecting high level periods and low level periods within a predetermined range, from among the high level periods and low level periods of the off-track signal which are measured by the off-track measurement unit, and outputting them to the measurement result integration unit; and the measurement result integration unit integrates the high level periods of the off-track signal and the low level periods thereof, respectively, which are supplied from the measurement result selection unit. Therefore, it is possible to ignore the measurement result of the off-track signal which is locally in the on-track state, and the influence of noises, whereby adjustment, of the off-track level can be carried out more appropriately.

Further, the optical disc device according to the present invention further includes a track crossing number measurement unit for measuring the number of track crossings in each of plural sector areas which are obtained by equally dividing the recording surface of the optical disc into n pieces of sectors on the basis of a 1/n rotation signal from the disc motor and the off-track signal, selecting a predetermined sector area on the basis of the number of track crossings in each sector area, and instructing the measurement result integration unit of a period during which the beam spot exists in the selected sector area; and the measurement result integration unit performing integration during the period instructed from the track crossing number measurement unit. Since the measurement result obtained in the sector area having the smallest number of track crossings among the respective sector areas is not subjected to integration, the measurement result which might be locally in the on-track state can be ignored, whereby adjustment of the off-track level can be carried out more appropriately.

Further, the optical disc device according to the present invention further comprises a servo control unit for performing tracking servo control in the optical pickup; and the off-track level adjustment unit performing adjustment of the off-track level when the beam spot of laser light crosses tracks under the tracking servo control.

Further, in the optical disc device according to the present invention, the off-track level adjustment unit performs adjustment of the off-track level when an access accompanied with a track jump over plural tracks (multi jump) is carried out under the tracking servo control.

Further, the optical disc device according to the present invention further comprises a servo control unit for performing traverse servo control of the optical pickup; and the off-track level adjustment unit performing adjustment of the off-track level when the beam spot of laser light crosses tracks under the traverse servo control.

Further, in the optical disc device according to the present invention, the off-track level adjustment unit performs adjustment of the off-track level when the optical pickup moves toward the inner circumference of the optical disc under the traverse servo control, at initial starting of the optical disc device.

Further, in the optical disc device according to the present invention, the servo control unit performs tracking servo control in the optical pickup; and the off-track level adjustment unit performs adjustment of the off-track level when an access accompanied with a track jump over plural tracks (traverse seek) is carried out under the traverse servo control and the tracking servo control.

Further, the optical disc device according to the present invention further comprises a track crossing speed measurement unit for measuring the track crossing speed of the beam spot on the basis of the cycle of the off-track signal, and instructing the measurement result integration unit of a period during which the track crossing speed is within a predetermined range; and the measurement result integration unit performs integration during the period instructed by the track crossing speed measurement unit. Therefore, adjustment of the off-track level can be carried out in the stable off-track state, whereby the precision of adjustment can be improved.

Further, in the optical disc device according to the present invention, the off-track level adjustment unit performs adjustment of the off-track level while performing plural times of track jumps. Therefore, an appropriate off-track level can be continuously maintained. Further, although, in some optical discs, an appropriate off-track level at its inner circumference may differ from that at its outer circumference, the present invention can cope with such case.

### BRIEF DESCRIPTION OF THE DRAWINGS

FIG. 1 is a block diagram illustrating the construction of an optical disc device according to first to fifth embodiments of the present invention.

FIG. 2 is a diagram illustrating an OFTRL adjusting process in an optical disc device corresponding to claims 1 to 5.

FIG. 3 is a block diagram illustrating the construction of an optical disc device according to the first embodiment of the present invention.

FIG. 4 is a waveform diagram illustrating an envelope signal and an off-track signal.

FIG. 5 is a diagram illustrating an OFTRL adjusting process in an optical disc device corresponding to claim 2.

FIG. 6 is a waveform diagram illustrating an envelope signal and an off-track signal.

FIG. 7 is a block diagram illustrating the construction of an optical disc device according to the second embodiment of the present invention.

FIG. 8 is a diagram for explaining integration of high level periods of an off-track signal and integration of low level periods thereof in a measurement result integration unit according to the second embodiment of the present invention.

FIG. 9(a) is a diagram illustrating movement of a beam spot during an access, and FIG. 9(b) is a diagram illustrating waveforms of an envelope signal and an off-track signal.

FIG. 10 is a waveform diagram illustrating a 1/n rotation signal, an envelope signal, and an off-track signal.

FIG. 11 is a block diagram illustrating the construction of an optical disc device according to the third embodiment of the present invention.

FIG. 12 is a waveform diagram illustrating an envelope signal and an off-track signal.

FIG. 13 is a block diagram illustrating the construction of an optical disc device according to the fourth embodiment of the present invention.

FIG. 14(a) is a diagram illustrating an optical disc that is divided into equal sector areas, and FIG. 14(b) is a waveform diagram illustrating a 1/n rotation signal, an envelope signal, and an off-track signal.

FIG. 15 is a block diagram illustrating the construction of an optical disc device according to the fifth embodiment of the present invention.

FIG. 16 is a block diagram illustrating the construction of an optical disc device according to a sixth embodiment of the present invention.

FIG. 17 is a diagram illustrating an OFTRL adjusting process in an optical disc device corresponding to claims 7, 8, 9, 10, 11, and 12.

FIG. 18 is a waveform diagram illustrating an envelope signal and an off-track signal.

FIG. 19 is a block diagram illustrating the construction of a conventional optical disc device.

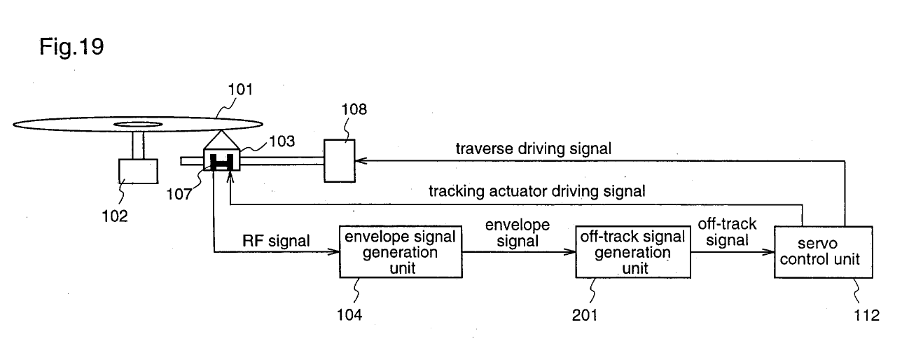

FIG. 20 is a diagram illustrating an OFTRL adjusting process in the conventional optical disc device.

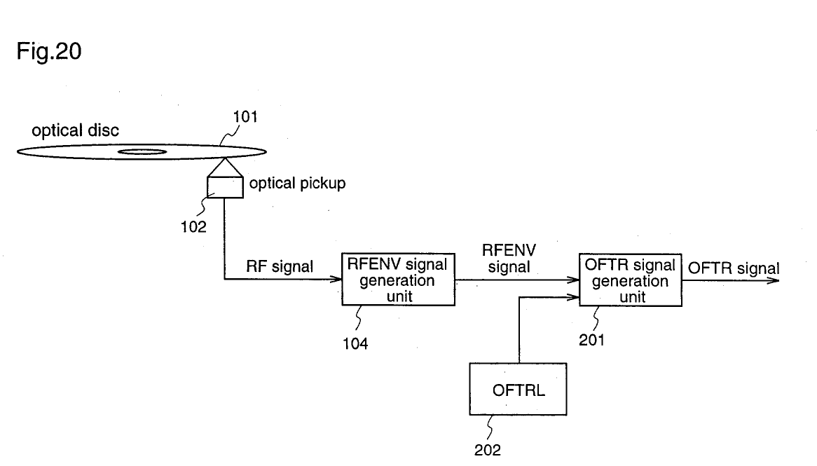

FIG. 21 is a diagram for explaining generation of an off-track signal from a RF signal.

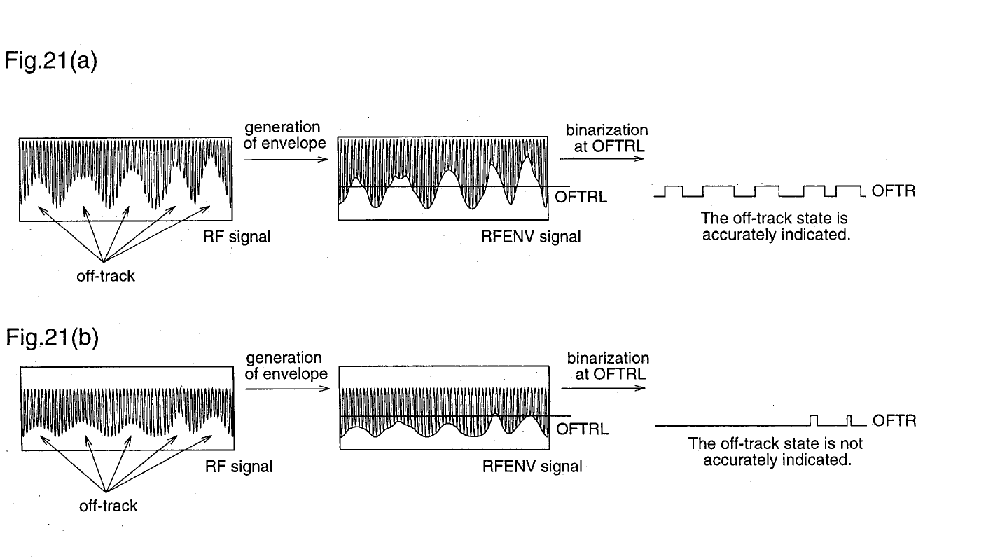

### PREFERRED EMBODIMENTS OF THE INVENTION

### Embodiment 1

Hereinafter, an optical disc device according to a first embodiment of the present invention will be described with reference to the drawings.

Initially, before describing the first embodiment, the construction of an optical disc device that covers first to fifth embodiments of the invention will be described.

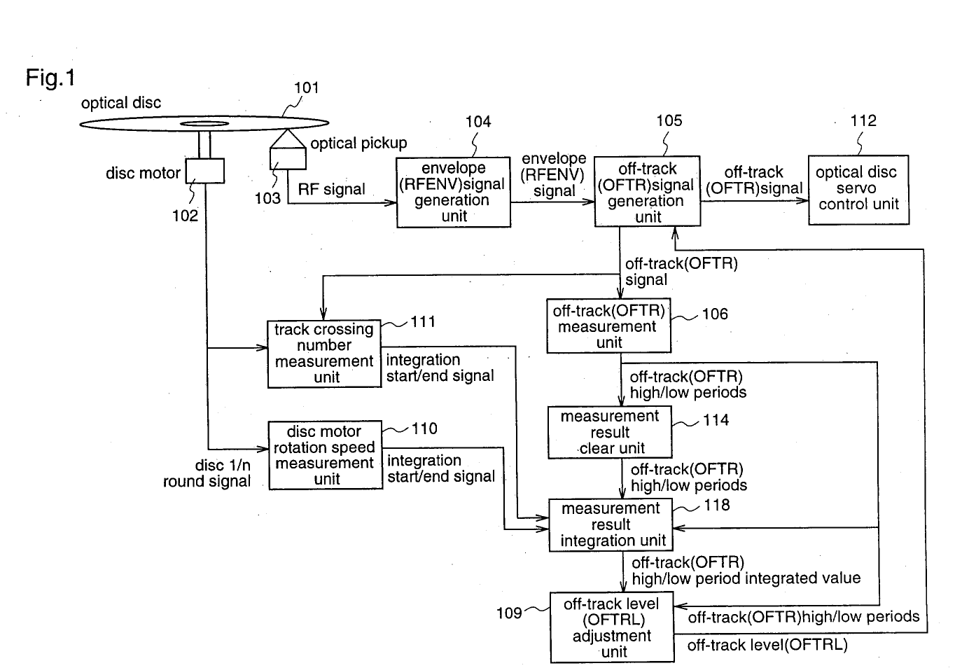

FIG. 1 is a diagram illustrating examples of functional blocks constituting the optical disc device according to the first to fifth embodiments of the invention, which corresponds to all of claims 1, 2, 3, 4, 5, and 6.

In FIG. 1, reference numeral 101 denotes an optical disc in which data are recorded on tracks. Reference numeral 102 denotes a disc motor which rotates and drives the optical disc 101. Reference numeral 103 denotes an optical pickup which irradiates the optical disc 101 with laser light, and receives the reflected light with a photodetector (not shown). Reference numeral 104 denotes an envelope (RFENV) signal generation unit for generating an envelope signal of a RF signal, which receives a reflected light signal (RF signal) from the optical pickup 103, and generates an envelope signal (RFENV signal) of the RF signal. Reference numeral 105 denotes an off-track (OFTR) signal generation unit for generating an off-track signal, which receives the RFENV signal from the RFENV signal generation unit 104, and binarizes this RFENV signal using an off-track level (OFTRL) signal that is a certain slice level. Reference numeral 106 denotes an OFTR measurement unit which receives the OFTR signal from the OFTR generation unit 104, and measures the time periods during which the OFTR signal is high, and the time periods during which the OFTR signal is low. Reference numeral 114 denotes a measurement result clear unit which receives the OFTR signal “high” periods and the OFTR signal “low” periods from the OFTR measurement unit 106, and clears the measurement results longer than a predetermined period, to “0”. Reference numeral 118 denotes a measurement result integration unit which receives the OFTR signal “high” periods and the OFTR signal “low” periods, and integrates the respective periods. Reference numeral 109 denotes an off-track level (OFTRL) adjustment unit which receives the OFTR signal “high” periods and the OFTR signal “low” periods, and adjusts the OFTRL according to the ratio between them. Reference numeral 110 denotes a disc motor rotation speed measurement unit which receives a disc 1/n rotation (n: natural number) pulse from the disc motor 102, and measures the disc rotation speed. Reference numeral 111 denotes a track crossing number measurement unit which receives the disc 1/n rotation pulse from the disc motor 102, divides the disc into plural areas, and measures the number of track crossings in each area from the OFTR signal. Reference numeral 112 denotes a common optical disc servo control unit which performs usual servo control on the optical disc.

The optical disc device according to the first embodiment of the invention generates an appropriate off-track signal by adjusting the off-track level to an appropriate level.

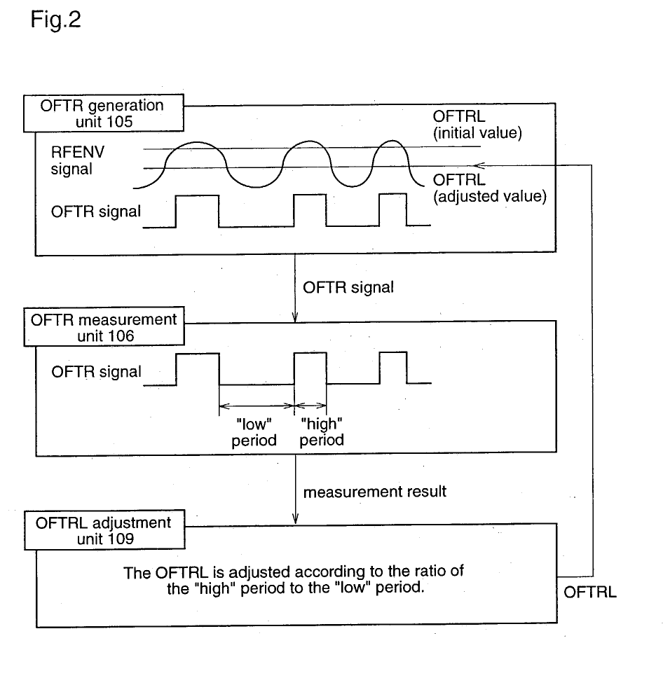

FIG. 2 shows the fundamental construction of a part performing OFTAL adjustment in the optical disc device according to the first embodiment of the invention. Hereinafter, the OFTAL adjustment operation will be described step by step.

In the optical disc device shown in FIG. 2, the OFTR generation unit 105 binarizes the RFENV signal using an initial value of OFTAL which has previously been determined. The OFTR measurement unit 106 receives the OFTR signal generated by the OFTR generation unit 105, and measures the periods during which the OFTR signal is high, and the periods during which the OFTR signal is low. The OFTRL adjustment unit 109 adjusts the OFTRL according to the ratio between the length of the OFTR signal “high” periods and the length of the OFTR signal “low” periods, and transmits the OFTRL to the OFTR generation unit 105. After the OFTRL adjustment, the OFTR generation unit 105 binarizes the RFENV signal using the OFTRL adjusted by the OFTRL adjustment unit 109, thereby generating an OFTR signal.

The OFTRL may be adjusted so that the ratio between the OFTR signal “high” periods and the OFTR signal “low” periods becomes optimum, by repeatedly performing measurement of the OFTR signal and adjustment of the OFTRL.

The ratio between the OFTR signal “high” periods and the “low” periods may be set to a value that is unique to the optical disc device. Alternatively, it may be set according to the medium, i.e., the optical disc.

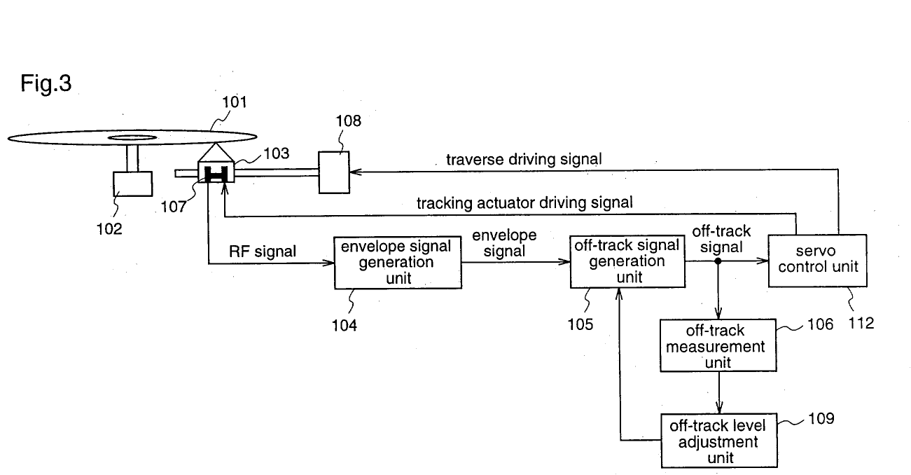

FIG. 3 is a block diagram illustrating the construction of an optical disc device according to the first embodiment of the present invention, which corresponds to claim 1.

The disc motor 102 rotates the optical disc 101 under the control of the servo control unit 112 via a path (not shown). The optical pickup 103 irradiates the optical disc 101 with laser light via an objective lens (not shown), and receives the reflected light to generate a RF signal. Further, the optical pickup 103 has a tracking actuator 107 which drives the objective lens (not shown) in the tracking direction according to a tracking actuator driving signal supplied from the servo controller 112, thereby making the beam spot of laser light follow the tracks on the optical disc 101. The envelope signal generation unit 104 generates an envelope signal on the basis of a RF signal from the optical pickup 103. The off-track signal generation unit 105 compares the envelope signal with a predetermined off-track level, and generates an off-track signal by binarizing the envelope signal using the off-track level as a slice level. The servo control unit 112 performs usual servo control in an optical disc device, that is, it performs tracking servo control in the optical pickup 103, traverse servo control of the optical pickup 103, rotation control of the disc motor 102, and the like, on the basis of the off-track signal. The traverse driving unit 108 traverse-drives the optical pickup 103 in the direction of the radius of the optical disc 101, according to a traverse driving signal supplied from the servo control unit 112. The off-track measurement unit 106 measures the high level periods and low level periods of the off-track signal. The off-track level adjustment unit 109 adjusts the off-track level that is set on the off-track signal generation unit 105, on the basis of the ratio between the high level periods and the low level periods.

Next, the operation of the optical disc device according to the first embodiment will be described.

The optical pickup 103 irradiates the optical disc 101 with laser light while being controlled by the servo control unit 112, receives the reflected light from the optical disc 101 to generate a RF signal, and outputs the RF signal to the envelope signal generation unit 104. The envelope signal generation unit 104 generates an envelope signal on the basis of the RF signal from the optical pickup 103, and outputs the envelope signal to the off-track signal generation unit 105. The off-track signal generation unit 105 outputs an off-track signal which is obtained by binarizing the envelope signal from the envelope signal generation unit 104, using a predetermined off-track level as a slice level, to the servo control unit 112 and the off-track measurement unit 106. When the device is started, the off-track signal generation unit 105 performs binarization of the envelope signal using an initial value of off-track level that has been previously set. After the off-track level is adjusted by the off-track level adjustment unit 109, the off-track signal generation unit 105 performs binarization of the envelope signal using the adjusted off-track level.

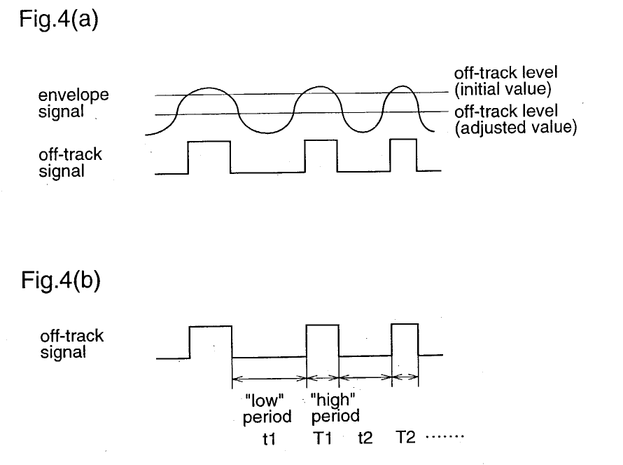

FIG. 4(a) is a waveform diagram for explaining the relationship between the envelope signal and the off-track signal. In the case where the envelope signal shown in the upper stage of FIG. 4(a) is input to the off-track signal generation unit 105, when the off-track level is the initial value, the off-track signal shown in the lower stage of FIG. 4(a) is generated by the off-track signal generation unit 105.

The off-track measurement unit 106 measures the high level periods during which the binarized off-track signal supplied from the off-track signal generation unit 105 is high, and low level periods during which the binarized off-track signal is low, and outputs the result of measurement to the off-track level adjustment unit 110.

FIG. 4(b) is a waveform diagram for explaining the low level periods (t1, t2 . . . ) and the high level periods (T1, T2 . . . ) which are measured by the off-track measurement unit 106. As shown in FIG. 4(b), the off-track measurement unit 106 outputs the low level periods and the high level periods in order of t1, T1, t2, T2, t3, T3 . . . to the off-track level adjustment unit 109. Although FIG. 4(b) shows the off-track signal that is obtained using the initial off-track level as a slice level, when the off-track level is adjusted by the off-track level adjustment unit 109, an off-track signal different from that shown in FIG. 4(b) will be obtained. The same can be said of waveform diagrams described hereinafter.

The off-track level adjustment unit 109 receives the low level periods and the high level periods from the off-track measurement unit 106, obtains the ratio between the low level periods and the high-level periods, and adjusts the off-track level that is set on the off-track signal generation unit 105, on the basis of the ratio. In the case where the low level periods and the high level periods are output from the off-track measurement unit 106 in order of t1, T1, t2, T2, t3, T3 . . . as described above, when the off-track level adjustment unit 109 initially receives t1 and T1, it obtains the ratio between the low-level period and the high level period, i.e., “t1/T1”, and adjusts the off-track level set on the off-track signal generation unit 105 on the basis of the ratio. This adjustment is performed by, for example, adding or subtracting a predetermined minute amount to/from the off-track level. To be specific, when it is judged from the ratio “t1/T1” between the low level period and the high level period that the off-track level is too high, the predetermined minute amount is subtracted from the off-track level set on the off-track signal generation unit 105. On the other hand, when it is judged from the ratio “t1/T1” that the off-track level is too low, the predetermined minute amount is added to the off-track level. Also when the off-track level adjustment unit 109 receives t2, T2, t3, T3 . . . , it obtains the ratio between the low level period and the high level period, i.e., “t2/T2”, “t3/T3”, . . . , and adjusts the off-track level on the basis of the ratio.

By repeating the off-track level adjustment with the off-track level adjustment unit 109, the ratio between the high level periods of the off-track signal and the low level periods thereof is adjusted to an optimum value, whereby the off-track signal outputted from the off-track signal generation unit 105 is optimized. The ratio between the high level periods and the low level periods which optimizes the off-track signal may be a value unique to the optical disc device, or it may be set for each medium, i.e., each optical disc.

As described above, the optical disc device according to the first embodiment is provided with the off-track signal generation unit 105 which generates an off-track signal by binarizing an envelope signal using an off-track level as a slice level; the off-track measurement unit 109 which measures high-level periods and low-level periods of the off-track signal; and an off-track level adjustment unit 110 which adjusts the off-track level that is set on the off-track signal generation unit 105, on the basis of the ratio between the high-level periods of the off-track signal and the low-level periods thereof. Therefore, the off-track level can be adjusted to an appropriate level, whereby an appropriate off-track signal can be generated. Using this off-track signal avoids occurrence of errors in measuring the number of cross tracks at seeking, thereby avoiding an increase in time required for access, a reduction in readability, and the like.

### Embodiment 2

Hereinafter, an optical disc device according to a second embodiment of the present invention will be described with reference to the drawings.

The optical disc device according to the second embodiment integrates “high” periods and “low” periods of an off-track signal, respectively, and adjusts the off-track level according to the ratio between the respective integration results.

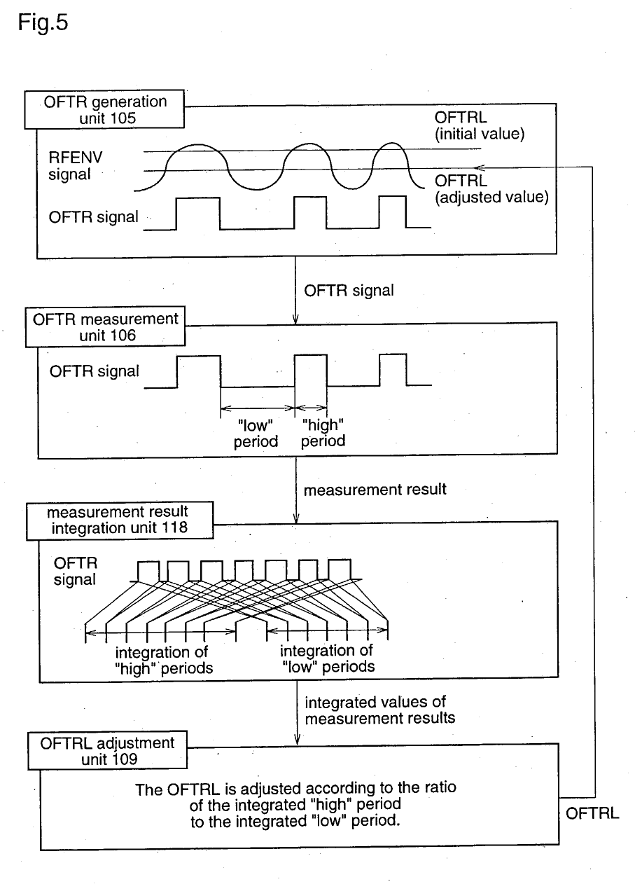

FIG. 5 shows OFTRL adjustment by the optical disc device according to the second embodiment of the invention, which corresponds to claim 2.

In the optical disc device corresponding to claim 2 and shown in FIG. 5, the optical disc device corresponding to claim 1 further includes a measurement result integration unit 118 which receives OFTR signal “high” periods and OFTR signal “low” periods from the OFTR measurement unit 106, and performs integration of the measured “high” periods and integration of the measured “low” periods, respectively. Then, the OFTRL adjustment unit 109 adjusts the OFTRL on the basis of the ratio between the integrated OFTR signal “high” period and the integrated OFTR signal “low” period.

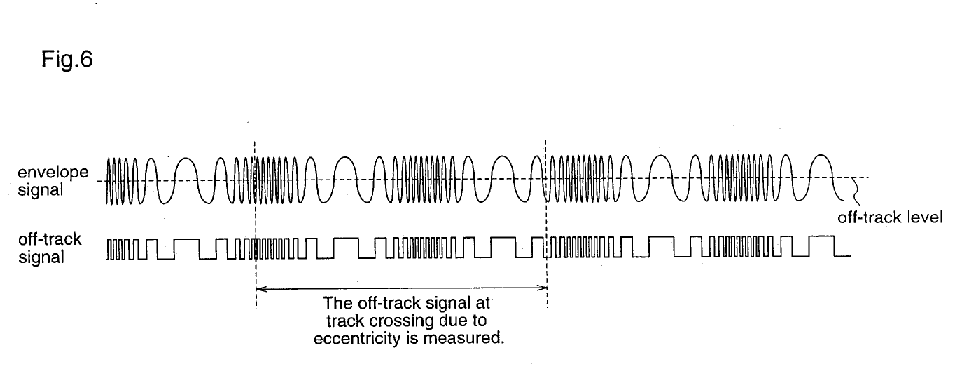

FIG. 6 shows OFTR signal measurement by the optical disc device according to the second embodiment of the invention, which corresponds to claim 3. When the laser spot is held on the recording surface of the optical disc by a general optical disc servo controller and the disc motor and the optical disc are eccentric, the beam spot crosses the tracks, whereby an envelope (RFENV) signal as shown in FIG. 6 is obtained. Further, when the RFENV signal is binarized with the OFTRL, an off-track (OFTR) signal as shown in FIG. 6 is obtained. The optical disc device corresponding to claim 3 measures this OFTR signal in like manner as described for the optical disc device corresponding to claim 1 or 2, and adjusts the OFTRL on the basis of the measurement result.

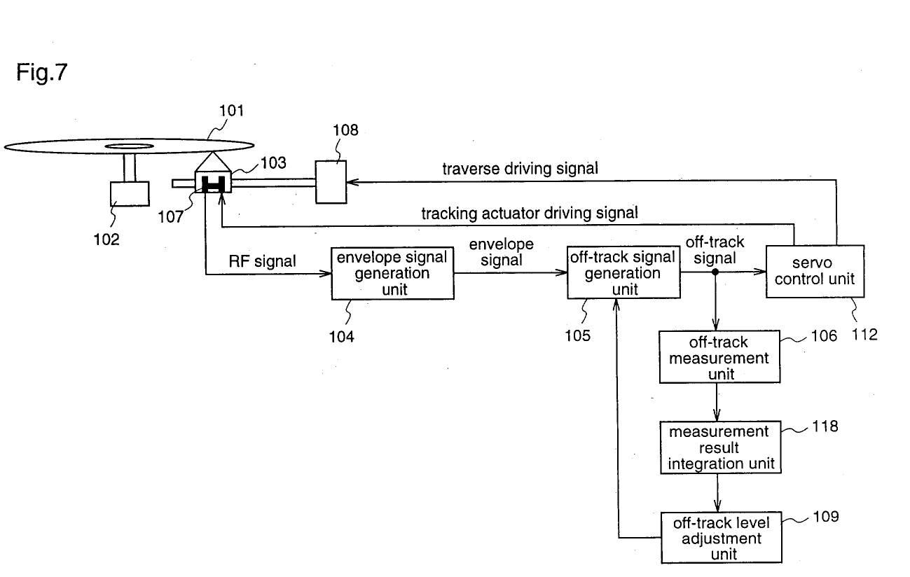

FIG. 7 is a block diagram illustrating the construction of the optical disc device according to the second embodiment. The same reference numerals as those shown in FIG. 3 denote the same elements as those of the optical disc device according to the first embodiment, and therefore, descriptions thereof will be omitted.

The measurement result integration unit 118 integrates the high level periods of the off-track signal and the low level periods thereof, which are measured by the off-track measurement unit 106, respectively, and outputs the integrated high level period and the integrated low level period to the off-track level integration unit 109.

Next, the operation of the optical disc device according to the second embodiment will be described. The operation up to measurement of high level periods and low level periods of the off-track signal by the off-track measurement unit 106 is identical to that of the optical disc device according to the first embodiment, and therefore, description thereof will be omitted.

The measurement result integration unit 118 integrates the high level periods of the off-track signal and the low level periods thereof which are measured by the off-track measurement unit 106, respectively, for a predetermined period of time.

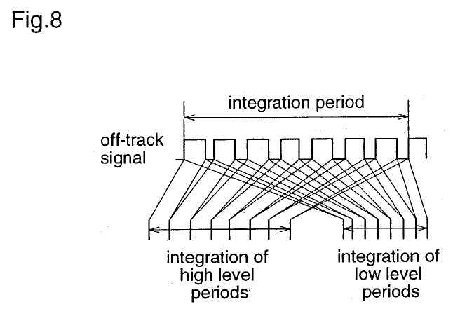

FIG. 8 is a diagram for explaining integration of the high level periods of the off-track signal and integration of the low level periods thereof by the measurement result integration unit 118. An integration period that is a predetermined period during which integration should be carried out is previously set on the measurement result integration unit 118. As shown in FIG. 8, the measurement result integration unit 118 integrates the high level periods and the low level periods which are supplied from the off-track measurement unit 106, respectively, during the integration period, and outputs the results to the off-track level adjustment unit 109. For example, when the off-track measurement unit 106 measures the low level periods and the high level alternately in order of t1, T1, t2, T2, t3, T3, . . . , the measurement result integration unit 118 calculates a low level period by integrating t1, t2, t3, . . . , and a high level period by integrating T1, T2, T3, . . . , and outputs the integrated low level period and the integrated high level period to the off-track level adjustment unit 109.

The off-track level adjustment unit 109 receives the integrated low level period and the integrated high level period from the off-track measurement unit 106, obtains the radio of the low level period to the high level period, and adjusts the off-track level set on the off-track signal generation unit 105, on the basis of the ratio, as described for the first embodiment.

The off-track level adjustment by the off-track level adjustment unit 109 may be repeatedly carried out, or it may be carried out only one time when the optical disc device is started if the integration period is appropriate. When the off-track level adjustment should be carried out only one time, the off-track level adjustment unit 109 does not perform addition/subtraction of a minute value to/from the off-track level but performs adjustment of the off-track level so as to obtain an off-track level that is determined on the basis of the ratio between the integrated low level period and the integrated high level period. By adjusting the off-track level in this way, the ratio between the high level period of the off-track signal and the low level period thereof is adjusted to be an optimum value, whereby the off-track signal outputted from the off-track signal generation unit 105 is optimized. The ratio between the high level period of the off-track signal and the low level period thereof which optimizes the off-track signal may be a value unique to the optical disc device, or it may be set for each medium, i.e., each optical disc.

As described above, the optical disc device according to the second embodiment further includes the measurement result integration unit 118 for integrating the high level periods of the off-track signal and the low level periods thereof which are measured by the off-track measurement unit 106, respectively, and the off-track level adjustment unit 109 adjusts the off-track level on the basis of the ratio between the integrated high level period and the integrated low level period which are obtained by the measurement result integration unit 118. Since the high level periods and the low level periods are respectively integrated, even when the high level periods (low level periods) vary one by one, adjustment of the off-track level can be carried out by averaging them, in addition to the effects achieved by the first embodiment. Therefore, errors in measurement due to influences of noise and the like can be avoided, whereby adjustment of the off-track level can be carried out more appropriately.

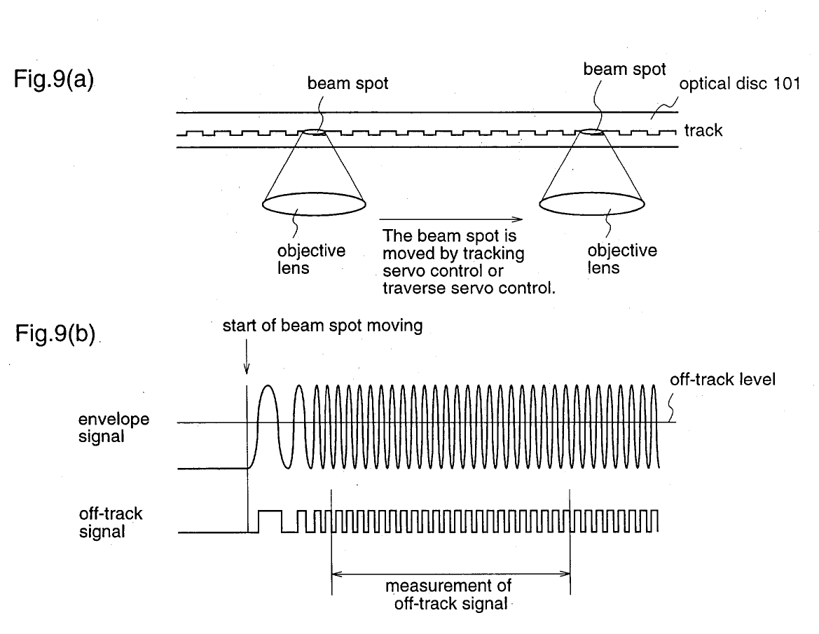

Although adjustment of the off-track level is carried out under the off-track state in the optical disc devices according to the first and second embodiments, since the off-track signal alternately repeats the high level and the low level when the beam spot of laser light crosses the tracks in the recording surface of the optical disc 101 under tracking servo control or traverse servo control by the servo control unit 106 as shown in FIG. 9(a), the off-track level can be adjusted using the off-track signal. For example, adjustment of the off-track level can be carried out when performing an access accompanied with a track jump over plural tracks due to tracking servo control (multi jump) or an access accompanied with a track jump over plural tracks due to tracking servo control and traverse servo control (traverse seek), or when the optical pickup 103 moves toward the inner circumference of the optical disc 101 under traverse servo control at initial startup of the optical disc device. When performing integration for a predetermined period of time as described for the second embodiment, as shown in FIG. 9(b), integration may be started after a short time has passed from when the beam spot started to move, whereby adjustment of the off-track level can be carried out with a stable off-track signal.

Further, the optical disc 101 may be rotated under the state where tracking servo control and traverse servo control are not carried out by the servo control unit 112, i.e., the state where the position of the beam spot of laser light is fixed on the recording surface of the optical disc 101, to generate an off-track state wherein the beam spot is controlled so as to cross the tracks by utilizing eccentricities of the optical disc 101 and the disc motor 102, and adjustment of the off-track level may be carried out under this off-track state. In this case, adjustment of the off-track level can be carried out without performing tracking servo control and traverse servo control, whereby an envelope signal and an off-track signal as shown in FIG. 6 can be obtained.

### Embodiment 3

Hereinafter, an optical disc device according to a third embodiment of the invention will be described with reference to the drawings. The optical disc device according to the third embodiment rotates the optical disc in the state where tracking servo control and traverse servo control are not carried out, i.e., the state where the position of the beam spot of laser light is fixed, to generate an off-track state wherein the beam spot is moved so as to cross the tracks by utilizing eccentricities of the optical disc and the disc motor, and adjusts the off-track level under this off-track state.

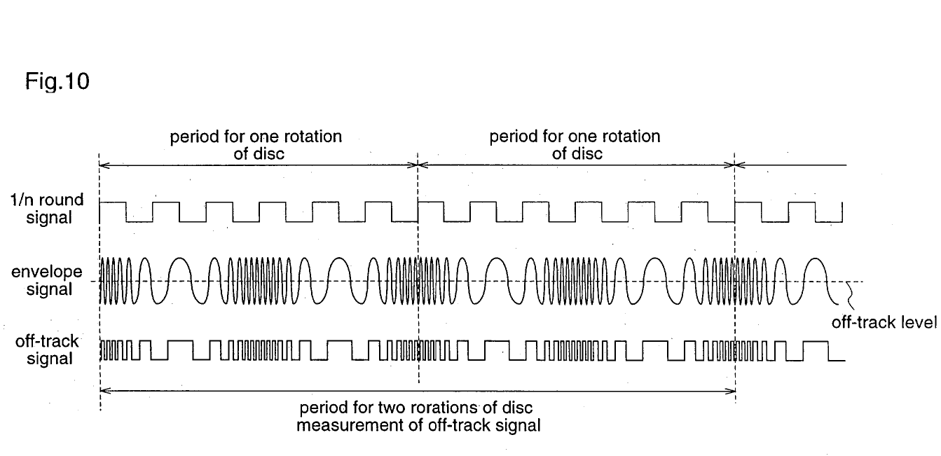

FIG. 10 shows OFTR signal measurement by the optical disc device according to the third embodiment of the invention, which corresponds to claim 4. In the optical disc device corresponding to claim 4, a disc motor rotation speed measurement unit is added to the optical disc device corresponding to claim 3, and the rotation speed of the disc motor is measured by the disc motor rotation speed measurement unit. Further, the disc motor rotation speed measurement unit transmits an integration start/end signal to the measurement result integration unit. It is assumed that the time from start to end of integration is equal to n rotations of the optical disc, and the OFTR signal is measured for a period during which the optical disc makes n rotations (n: natural number). Adjustment of the OFTRL is carried out on the basis of the ratio between the integrated high level period and the integrated low level period of the OFTR signal equivalent to n rotations of the optical disc, in like manner as described for the optical disc device of claim 1. FIG. 10 shows measurement for two rotations of the optical disc, wherein a FG signal (1/n rotation signal) rises at every ⅙ rotation of the optical disc.

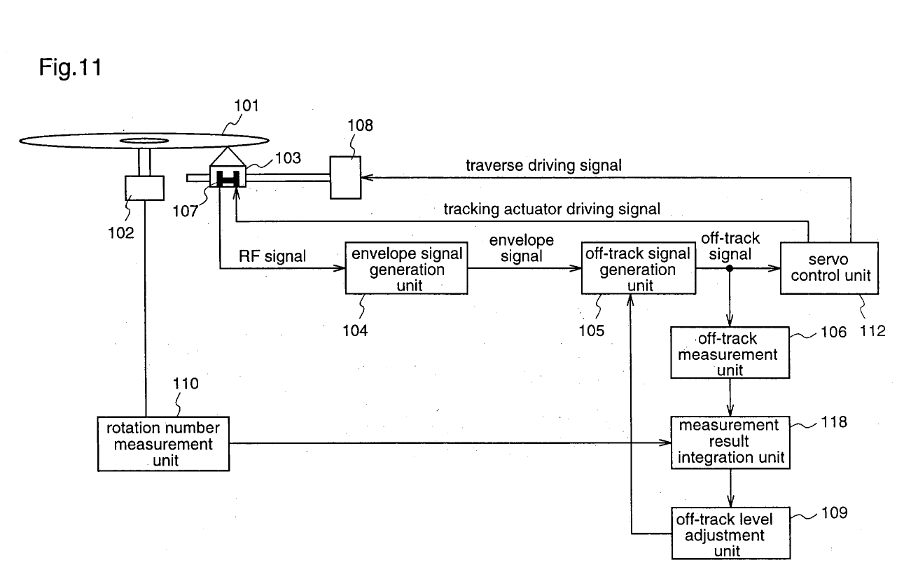

FIG. 11 is a block diagram illustrating the construction of the optical disc device according to the third embodiment. The same reference numerals as those shown in FIG. 7 denote the same elements as those of the optical disc device according to the second embodiment and, therefore, descriptions thereof will be omitted.

A rotation number measurement unit (disc motor rotation speed measurement unit) 110 measures the number of rotations of the optical disc 101, and instructs the measurement result integration unit 118 of a period during which the optical disc 101 rotates m times (m: integer equal to or larger than 1).

Although the measurement result integration unit 118 is identical to the measurement result integration unit 118 according to the second embodiment, an integration period during which the integration unit 118 according to this third embodiment performs integration is not a predetermined period but a period which is instructed from the rotation number measurement unit 112.

Next, the operation of the optical disc device according to the third embodiment will be described. The operation up to measurement of high level periods and low level periods of the off-track signal by the off-track measurement unit 106 is identical to the operation of the optical disc device according to the second embodiment, and therefore, description thereof will be omitted.

FIG. 10 is a waveform diagram illustrating a 1/n rotation signal generated by the disc motor 102, an envelope signal, and an off-track signal. When the optical disc 101 is rotated with the beam spot of laser light being fixed on the recording surface of the optical disc 101, the beam spot crosses the tracks due to eccentricities of the optical disc 101 and the disc motor 102, whereby an envelope signal shown in the middle of FIG. 10 is generated.

The disc motor 102 generates a 1/n rotation signal that rises at every 1/n rotation (n: integer equal to or larger than 1) of the optical disc 101, which is shown in the upper stage of FIG. 10 (in FIG. 10, n=6). The rotation number measurement unit 110 measures the number of rotations of the optical disc 101 on the basis of the ½ rotation signal, and instructs the measurement result integration unit 118 of a period during which the optical disc 101 makes a predetermined number of rotations. To be specific, in the case where the rotation number measurement unit 110 instructs the measurement result integration unit 118 of a period equivalent to two rotations of the optical disc 101, the rotation number measurement unit 110 initially outputs a start signal indicating that the period equivalent to two rotations starts, to the measurement result integration unit 118, while the optical disc 101 is rotating. Thereafter, the rotation number measurement unit 110 judges that the optical disc 101 has made one rotation when there are n times of rising of the 1/n rotation signal, thereby measuring two rotations of the optical disc 101 (i.e., it counts the rising of the 1/n rotation signal by 2n times), and outputs an end signal indicating that the period is ended, to the measurement result integration unit 118, when the optical disc 101 has just made two rotations.

On receipt of the start signal from the rotation number measurement unit 110, the measurement result integration unit 118 starts integration of the high level periods of the off-track signal and the low level periods thereof, respectively. On receipt of the end signal, the measurement result integration unit 118 ends integration. That is, the measurement result integration unit 118 performs integration during a period equivalent to a predetermined number of rotations (m rotations) of the optical disc 101, which is set on the rotation number measurement unit 110. As shown in the lower stage of FIG. 10, the measurement result integration unit 118 performs integration of the high level periods and the low level periods, respectively, during the period in which the optical disc. 101 makes two rotations.

The operation of the off-track level adjustment unit 109 for adjusting the off-track level on the basis of the ratio between the integrated high level period and the integrated low level period is identical to that described for the second embodiment, and therefore, description thereof will be omitted.

As described above, according to the third embodiment, the optical disc device in which the position of the beam spot of the laser beam is fixed by performing no traverse servo control and no tracking servo control by the servo control unit 112 while rotating the optical disc 101 by the disc motor 102, further includes the rotation number measurement unit 110 which measures the number of rotations of the optical disc 101 and instructs the measurement result integration unit 118 of a period during which the optical disc 101 makes m rotations (m: integer equal to or larger than 1). In this device, the measurement result integration unit 118 performs integration during the period indicated by the number-of-revolutions measurement unit 110, whereby an off-track state is generated utilizing eccentricities of the optical disc 101 and the disc motor 102 to perform adjustment of the off-track level. Therefore, the off-track level can be adjusted without moving the optical pickup 103 or the objective lens possessed by the optical pickup 103. Further, since the measurement result integration unit 118 performs integration during a period of time equivalent to a predetermined number of rotations of the optical disc 101, adjustment of the off-track level can be carried out using the high level periods and the low level periods which are respectively averaged within the period of time, whereby adjustment of the off-track level can be carried out without being influenced by variations of the respective high level periods and low level periods.

### Embodiment 4

Hereinafter, an optical disc device according to a fourth embodiment of the present invention will be described with reference to the drawings. The optical disc device according to the fourth embodiment rotates the optical disc in the state where tracking servo control and traverse servo control are not carried out, i.e., in the state where the position of the beam spot of the laser beam is fixed, thereby to make an off-track state where the beam spot is moved so as to cross the track by utilizing eccentricities of the optical disc and the disc motor, thereby performing adjustment of the off-track level.

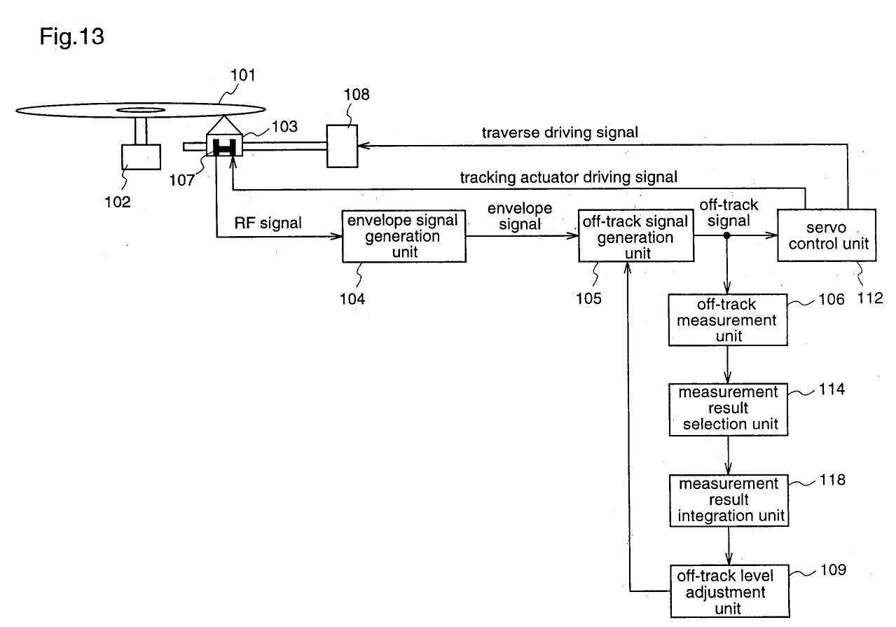

FIG. 13 shows OFTR signal measurement in the optical disc device according to the fourth embodiment of the invention, which corresponds to claim 5.

In the optical disc device corresponding to claim 5, a measurement result clear unit is added to the optical disc device corresponding to claim 3. In this device, among the OFTR signal “high” periods and “low” periods which are measured by the OFTR measurement unit 106, the measurement results which are longer or shorter than a predetermined period are ignored, and OFTRL adjustment is carried out on the basis of the result.

The measurement result clear unit transmits the measurement results to the measurement result integration unit 118 such that the measurement results of OFTR signal “high” periods and “low” periods which are longer than a predetermined period are set to “0”, or the measurement results of OFTR signal “high” periods and “low” periods which are shorter than a predetermined period are set to “0”. On receipt of the measurement results of the OFRT signal “high” periods and “low” periods from the measurement result clear unit, the measurement result integration unit 118 performs integration of the measurement results. Further, OFTRL adjustment is carried out in the same manner as described for the device corresponding to claim 1 or 2.

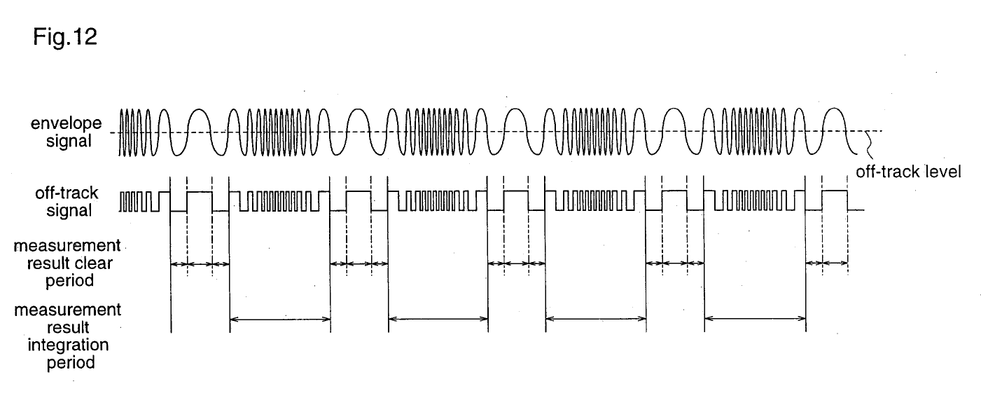

FIG. 12 shows a manner of OFTR signal measurement which is performed on only portions where the track crossing speed is high, by setting the measurement results longer than a predetermined period to “0”.

The measurement result clear unit may transmit only the measurement results which fall within a certain width (period) of time, to the measurement result integration unit 118, by setting the measurement results longer than a predetermined period and the measurement results shorter than a predetermined period to “0”.

FIG. 13 is a block diagram illustrating the construction of the optical disc device according to the fourth embodiment. The same reference numerals as those shown in FIG. 7 denote the same elements as those of the optical disc device according to the second embodiment, and therefore, repeated description is not necessary.

A measurement result selection unit (measurement result clear unit) 114 selects, from among the high level periods and low level periods of the off-track signal which are measured by the off-track measurement unit 106, the high level periods and the low level periods which are within predetermined ranges, respectively.

Next, the operation of the optical disc device according to the fourth embodiment will be described. The operation up to measurement of the off-track signal high level periods and low level periods by the off-track measurement unit 106 is identical to that of the optical disc device according to the second embodiment, and therefore, repeated description is not necessary.

FIG. 12 is a diagram illustrating waveforms of an envelope signal and an off-track signal. When the optical disc 101 is rotated with the beam spot of the laser light being fixed on the recording surface of the optical disc 101, the beam spot crosses the tracks due to eccentricities of the optical disc 101 and the disc motor 102, thereby generating an envelope signal as shown in the upper stage of FIG. 12. The off-track signal generation unit 105 binarizes the envelope signal to generate an off-track signal as shown in the lower stage of FIG. 12.

The measurement result selection unit 114 selects high level periods and low level periods which are shorter than a predetermined first threshold value from among the high level periods and low level periods of the off-track signal which are measured by the off-track measurement unit 106, and outputs them to the measurement result integration unit 118. In the case of FIG. 13, the high level periods and low level periods corresponding to the measurement result clear periods are not output to the measurement result integration unit 118 while the high level periods and low level periods corresponding to the measurement result integration periods are output to the measurement result integration unit 118.

Selection of the high level periods and low level periods lower than the first threshold value includes clearing (i.e., setting to “0”) the measurement results longer than the first threshold value, and outputting them to the measurement result integration unit 118.

The operation relating to integration of the high level periods and low level periods supplied from the measurement result selection unit 114, and the operation relating to adjustment of the off-track level based on the ratio between the integrated high level period and the integrated low level period, are identical to those described for the second embodiment, and therefore, repeated description is not necessary.

As described above, according to the fourth embodiment, the optical disc device in the state where the position of the beam spot of laser light is fixed by performing no traverse servo control and no tracking servo control with the servo control unit 112 while rotating the optical disc 101 with the disc motor 102, further includes the measurement result selection unit 114 for selecting the high level periods and low level periods within a predetermined range from among the high level periods and low level periods of the off-track signal which are measured by the off-track measurement unit 106, and outputting them to the measurement result integration unit 118. In this device, the measurement result integration unit 118 integrates the off-track signal high level periods and the off-track signal low level periods, respectively, to make an off-track state utilizing eccentricities of the optical disc 101 and the disc motor 102, whereby adjustment of the off-track level is carried out. Therefore, adjustment of the off-track level can be carried out without moving the optical pickup 103 or the objective lens possessed by the optical pickup 103. Further, since the measurement results larger than the first threshold value are not integrated, the measurement results of the off-track signal which is locally in the on-track state can be ignored, resulting in an effect that adjustment of the off-track level can be carried out more appropriately.

Especially when adjusting the off-track level utilizing the eccentricity of the optical disc 101 or the like, the off-track signal locally goes into the on-track state about four times while the optical disc 101 makes one rotation, and the measurement results of the off-track signal in these local on-track states are not selected, resulting in an increase in accuracy of off-track level adjustment.

The measurement result selection unit 114 may select high level periods and low level periods larger than a second threshold value that is different from the first threshold value, and output them to the measurement result integration unit 118. The second threshold value is a value smaller than the first threshold value. When the measurement result selection unit 114 selects the measurement results within such range, noises included in the off-track signal can be removed.

### Embodiment 5

Hereinafter, an optical disc device according to a fifth embodiment of the present invention will be described with reference to the drawings. The optical disc device according to the fifth embodiment rotates the optical disc in the state where tracking servo control and traverse servo control are not carried out, i.e., in the state where the position of the beam spot of laser light is fixed, to make an off-track state wherein the beam spot crosses the tracks, by utilizing eccentricities of the optical disc and the disc motor, thereby performing adjustment of the off-track level.

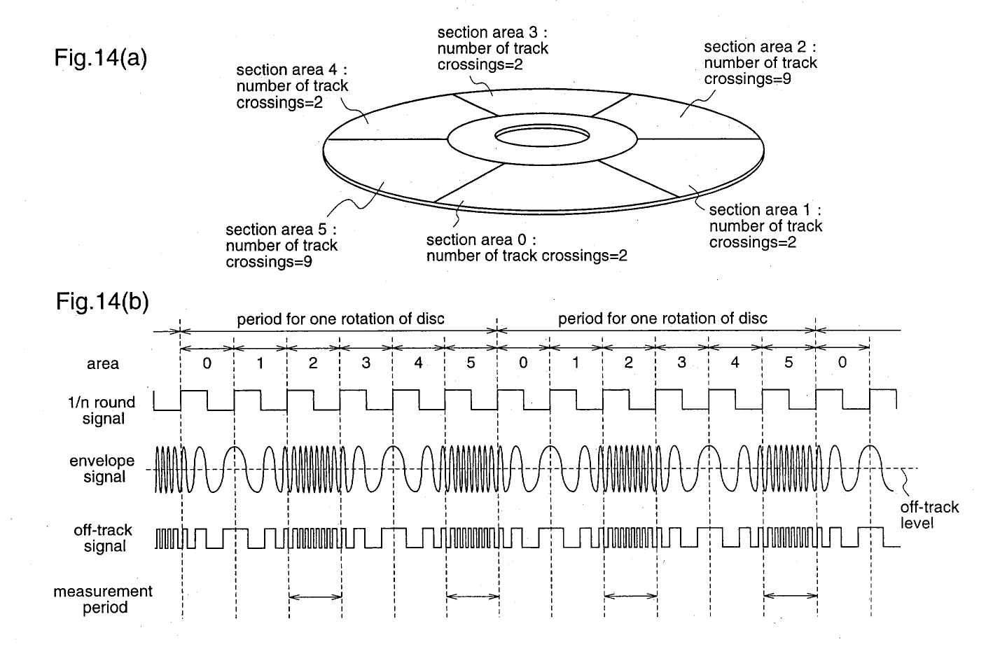

FIG. 14(a) illustrates area division on the optical disc and measurement of the OFTR signal in the optical disc device according to the fifth embodiment of the invention, which corresponds to claim 6.

In the optical disc device corresponding to claim 6, a track crossing number measurement unit is added to the optical disc device corresponding to claim 3, whereby the OFTR signal is measured at an appropriate track cross speed, and the OFTRL is adjusted on the basis of the result of the measurement.

The track crossing number measurement unit obtains an optical disc 1/n rotation signal from the disc motor, divides the optical disc into plural areas, and measures the number of track crossings in each area. Further, the track crossing number measurement unit outputs an integration start signal to the measurement result integration unit 118 at the beginning of an area where track crossing is appropriate, and further, it outputs an integration end signal at the end of the area. The measurement result integration unit 118 performs integration of the measured OFTR signal high periods and integration of the measured OFTR signal low periods, according to the integration start and end signals from the track crossing number measurement unit 111. Further, adjustment of the OFTRL is carried out in like manner as described for the optical disc device corresponding to claim 1 or 2.

FIG. 14(b) shows a case where the track crossing speeds in area 2 (sector area 2) and area 5 (sector area 5) are appropriate, and integration of the OFTR signal measurement results is carried out in the areas 2 and 5.

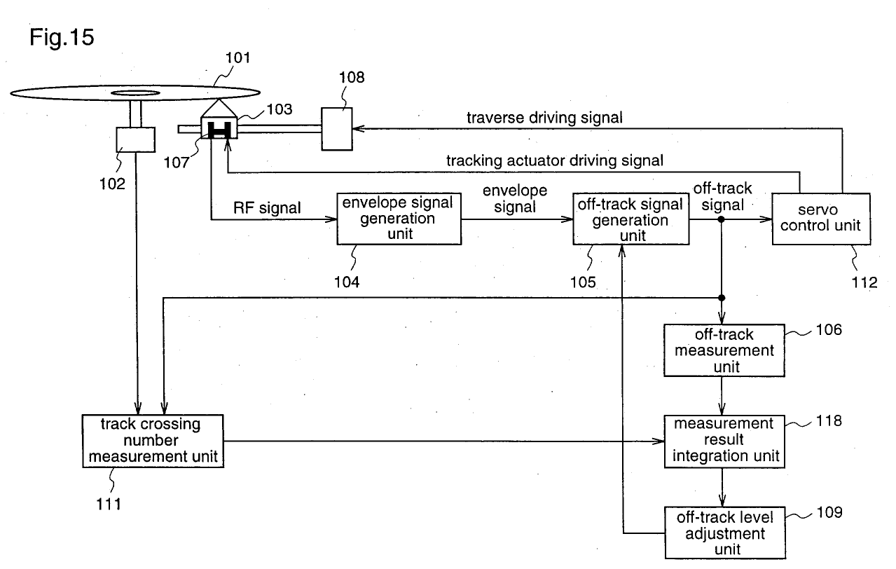

FIG. 15 is a block diagram illustrating the construction of the optical disc device according to the fifth embodiment. The same reference numerals as those shown in FIG. 7 indicate the same elements as those of the optical disc device according to the second embodiment, and therefore, repeated description is not necessary.

The disc motor 102 according to this fifth embodiment generates a 1/n rotation signal that rises at every 1/n rotation (n: integer equal to or larger than 2) of the optical disc 101, like the disc motor 102 according to the third embodiment.

The track crossing number measurement unit 111 measures the number of track crossings in each of the n pieces of sector areas into which the recording surface of the optical disc 101 is equally divided, on the basis of the 1/n rotation signal from the disc motor 102 and the off-track signal, and selects a predetermined sector area on the basis of the number of track crossings in each sector area, and instructs the measurement result integration unit 118 of a period during which the beam spot exists in the sector area.

Although the measurement result integration unit 118 is identical to the measurement result integration unit 118 according to the second embodiment, an integration period during which the integration unit 118 performs integration is not a predetermined period as in the second embodiment but a period indicated by the track crossing number measurement unit 111.

Next, the operation of the optical disc device according to the fifth embodiment will be described. The operation up to measurement of off-track signal high level periods and low level periods by the off-track measurement unit 106 is identical to the operation of the optical disc device according to the second embodiment, and therefore, repeated description is not necessary.

FIG. 14(b) is a diagram illustrating diagrams of a 1/n rotation signal generated by the disc motor 102, an envelope signal, and an off-track signal. When the optical disc 101 is rotated with the beam spot of the laser light being fixed on the recording surface of the optical disc 101, the beam spot crosses the tracks due to eccentricities of the optical disc 101 and the disc motor 102, whereby an envelope signal as shown in the center of FIG. 14(b) is generated. The off-track signal generation unit 105 binarizes the envelope signal, thereby generating an off-track signal as shown in the lower stage of FIG. 14(b).

The disc motor 102 generates a 1/n rotation signal that rises at every 1/n rotation (n: integer equal to or larger than 2) of the optical disc 101, which is shown in the upper stage of FIG. 14(b) (in FIG. 14(b), n=6).

The track crossing number measurement unit 111 receives the 1/n rotation signal from the disc motor 102, and measures the number of tracks over when the beam spot crosses, for every area from a certain rising of the 1/n rotation signal to a next rising, on the basis of the off-track signal from the off-track signal generation unit 105. The area from a certain rising to a next rising corresponds to each of the n pieces of sector areas into which the recording surface of the optical disc 101 is divided, as shown in FIG. 14(b). After the track crossing number measurement unit 111 measures the number of track crossings for each sector area as shown in FIG. 14(a), it selects sector areas other than a sector area having the smallest number of track crossings, and outputs, to the measurement result integration unit 118, a start signal from when the beam spot enters the selected area, as well as an end signal when the beam spot goes out of the selected area. In the case of FIG. 14(b), since the smallest number of track crossings is “2” among the sector areas, sector areas other than those having two track crossings, i.e., the sector area 2 and the second area 5, are selected.

The measurement result integration unit 118 starts integration of the off-track signal high level periods and integration of the off-track signal low level periods on receipt of the start signal from the track crossing number measurement unit 111, and ends the integration on receipt of the end signal. That is, the measurement result integration unit 118 performs integration during a period in which the beam spot is in the area selected by the track crossing number measurement unit 111. In the cases of FIGS. 14 and 15, the integration unit 118 performs integration during the measurement periods corresponding to the sector area 2 and the sector area 5.

The operation of the off-track level adjustment unit 109 for adjusting the off-track level on the basis of the ratio between the integrated high level period and the integrated low level period is identical to that described for the second embodiment, and therefore, repeated description is not necessary.

As described above, according to the fifth embodiment, the optical disc device in the state where the position of the beam spot of laser light is fixed by performing no traverse servo control and no tracking servo control by the servo control unit 112 while rotating the optical disc 101 with the disc motor 102, further includes the track crossing number measurement unit 111 which measures the number of track crossings in each of the n sector areas into which the recording surface of the optical disc 101 is equally divided, on the basis of the 1/n rotation signal and the off-track signal, and selects a predetermined sector area on the basis of the number of track crossings in each sector area, and instructs the measurement result integration unit 118 of a period during which the beam spot is in the selected sector area. In this device, the measurement result integration unit 118 performs integration during the period instructed from the track crossing number measurement unit 111 to make an off-track state utilizing eccentricities of the optical disc 101 and the disc motor 102, thereby adjusting the off-track level. Therefore, adjustment of the off-track level can be carried out without moving the optical pickup 103 or the objective lens possessed by the optical pickup 103. Further, since the measurement results in a sector area having the smallest number of track crossings among the plural sector areas are not integrated, the measurement results which might be locally in the on-track state can be ignored, whereby adjustment of the off-track level can be carried out more appropriately.

Especially when the off-track level is adjusted utilizing the eccentricity of the optical disc 101 or the like, there are about four points where on-track states are locally generated while the optical disc 101 makes one rotation. Therefore, selecting no off-track signal measurement results in such points leads to an increase in precision of off-track level adjustment.

The track crossing number measurement unit 111 may select sector areas other than a sector area having the largest number of track crossings among the plural sector areas. Thereby, noises included in the off-track signal can be removed.

### Embodiment 6

Hereinafter, an optical disc device according to a sixth embodiment of the present invention will be described with reference to the drawings. The optical disc device according to the sixth embodiment adjusts the off-track level while it performs an access accompanied with a track jump over plural tracks under tracking servo control (multi jump), or an access accompanied with a track jump over plural tracks under traverse servo control (traverse seek).

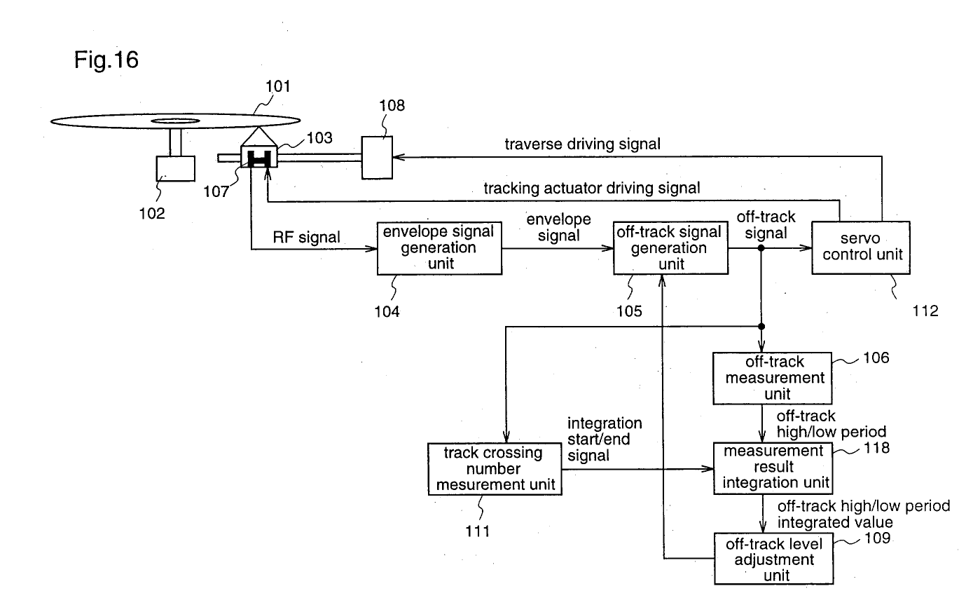

FIG. 16 is a diagram illustrating examples of function blocks constituting the optical disc device according to the sixth embodiment of the present invention, which corresponds to all of claims 7, 8, 9, 10, 11, 12, and 13.

In FIG. 16, reference numeral 101 denotes an optical disc on which data are recorded in tracks. Reference numeral 103 denotes an optical pickup which irradiates the optical disc 101 with laser light through an objective lens, and receives the reflected light with a photodetector. Reference numeral 103 denotes a tracking actuator which drives the objective lens of the optical pickup 103 to make a beam spot follow the tracks.

Reference numeral 108 denotes a traverse driving unit which moves the optical pickup 103 in the direction of the radius of the optical disc 101. Reference numeral 104 denotes an envelope (RFENV) signal generation unit which receives the signal of reflected light (RF signal) from the optical pickup 103, and generates an envelope signal (RFENV signal) thereof. Reference numeral 105 denotes an off-track (OFTR) signal generation unit which receives the RFENV signal from the RFENV generation unit 104, and binarizes the RFENV signal at an off-track level (OFTRL) that is a certain slice level. Reference numeral 106 denotes an OFTR measurement unit which receives the OFTR signal from the OFTR signal generation unit 105, and measures the periods of time where the OFTR signal is high as well as the periods of time where the OFTR signal is low. Reference numeral 118 denotes a measurement result integration unit (measured period integration unit) which receives the OFTR signal “high” periods and the OFTR signal “low” periods, and integrates the respective periods. Reference numeral 109 denotes an off-track level (OFTRL) adjustment unit which receives the time of the integrated OFTR signal “high” period and the time of the integrated OFTR signal “low” period, and adjusts the OFTRL on the basis of the ratio between them. Reference numeral 111 denotes a track crossing speed measurement unit (track crossing number measurement unit) which measures the cycle of the OFTR signal, and transmits an integration start signal and an integration end signal to the measurement result integration unit 118 when the cycle of the OFTR signal is appropriate. Reference numeral 112 denotes a general optical disc servo control unit which performs general control on the optical disc device.

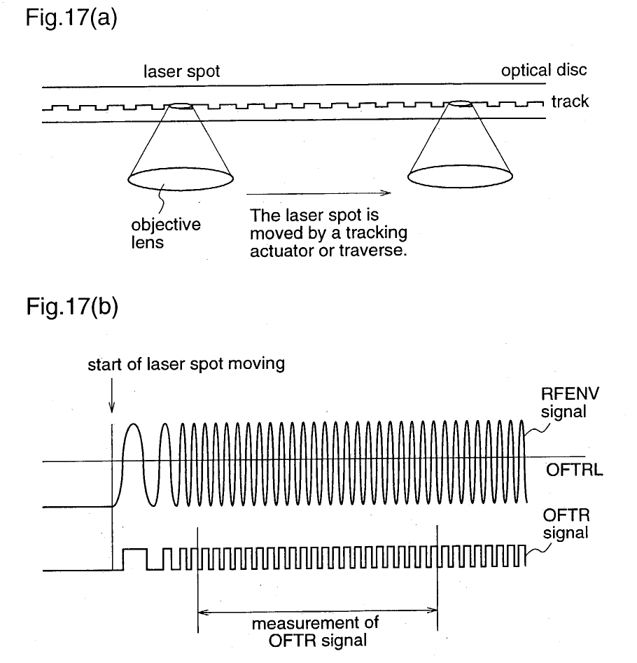

FIG. 17 shows OFTR signal measurement in the optical disc device corresponding to claims 7, 8, 9, 10, 11, 12, and 13.

In the optical disc device corresponding to claim 7, the laser spot is maintained on the recording surface of the optical disc by the general optical disc servo controller, and the objective lens of the optical pickup is driven by the tracking actuator. At this time, the beam spot crosses the tracks on the optical disc, whereby the OFTR signal alternately repeats “high” and “low”. This OFTR signal is measured in the same manner as described for the optical disc device corresponding to claim 1 or 2, and the OFTRL is adjusted on the basis of the measurement result.

In the optical disc device corresponding to claim 8, when the beam spot is moved by the tracking actuator (multi jump) for making an access to the optical disc, measurement of the OFTR signal is carried out in the same manner as described for the optical disc device corresponding to claim 7, and the OFTRL is adjusted.

In the optical disc device corresponding to claim 9, the laser spot is maintained on the recording surface of the optical disc by the general optical disc servo controller, and the optical pickup is moved by the traverse. At this time, the beam spot crosses the tracks on the optical disc, whereby the OFTR signal alternately repeats “high” and “low”. This OFTR signal is measured in the same manner as described for the optical disc device corresponding to claim 1 or 2, and the OFTRL is adjusted on the basis of the measurement result.

In the optical disc device corresponding to claim 10, when moving the traverse to the innermost circumference of the optical disc at initial startup of the optical disc, the OFTR signal is measured in the same manner as described for the optical disc device corresponding to claim 9, and then the OFTRL is adjusted.

In the optical disc device corresponding to claim 11, when the beam spot is moved by the traverse (traverse seek) for making an access to the optical disc, the OFTR signal is measured in the same manner as described for the optical disc device corresponding to claim 9, and then the OFTRL is adjusted.

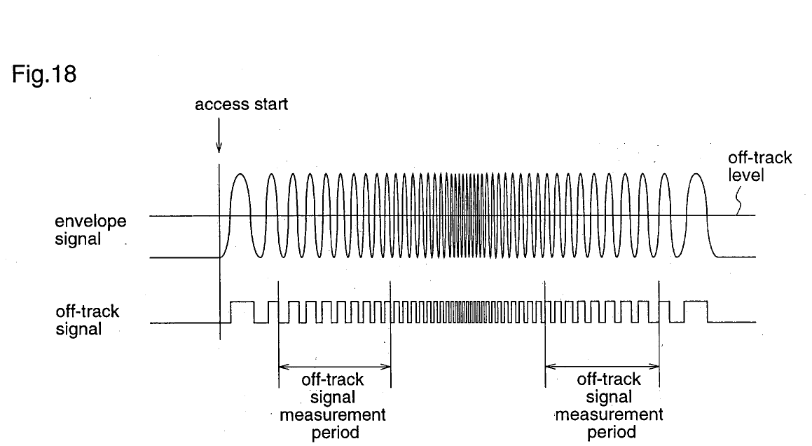

FIG. 18 shows OFTR signal measurement in the optical disc device corresponding to claim 12.

In the optical disc device corresponding to claim 12, a track crossing speed measurement unit 111 is added to the optical disc device corresponding to claim 8 or 11. The track crossing speed measurement unit 111 measures the track crossing speed of the beam spot on the basis of the cycle of the OFTR signal, and transmits an integration start signal and an integration end signal to the measurement result integration unit 118, whereby the OFTR signal is measured and the OFTRL is adjusted when the track crossing speed is appropriate.

The track crossing speed of the beam spot may be obtained from the traverse speed during general traverse seek.

In the optical disc device corresponding to claim 13, the OFTRL adjustment on the optical disc corresponding to claim 12 is carried out at every access to the optical disc, whereby the OFTRL is maintained at an appropriate level during recording/playback of the optical disc.

FIG. 16 is a block diagram illustrating the construction of the optical disc device according to the sixth embodiment. The same reference numerals as those shown in FIG. 7 denote the same elements as those of the optical disc device according to the second embodiment, and therefore, repeated description is not necessary.

The track crossing speed measurement unit 111 measures the track crossing speed of the beam spot of laser light on the basis of the cycle of the off-track signal, and instructs the measurement result integration unit 118 of a period during which the track crossing speed is within a predetermined range.

Although the measurement result integration unit 118 is identical to the measurement result integration unit 118 according to the second embodiment, it does not perform integration during a predetermined period as in the second embodiment, but performs integration during a period indicated by the track crossing speed measurement unit 111.

Next, the operation of the optical disc device according to the sixth embodiment will be described.

FIG. 18 is a diagram illustrating waveforms of an envelope signal and an off-track signal.

As shown in FIG. 18, immediately after starting an access accompanied with a jump over plural tracks due to tracking servo control or traverse servo control, the position of the beam spot is in the accelerating state, and the off-track state is not stable (i.e., even when the off-track level is appropriate, the ratio between the high level period and the low level period can be judged as inappropriate). Therefore, when the off-track level is adjusted using the off-track signal at this time, the precision of the off-track level is lowered. The same can be said of the off-track state immediately before the end of access. Further, if adjustment of the off-track level is carried out when the cycle of the off-track signal is too long, it can easily be affected by noises. Accordingly, adjustment of the off-track level should be carried out when the off-track state is stable, i.e., when the speed at which the beam spot of laser light crosses the tracks is within a predetermined range.

For this purpose, the track crossing speed measurement unit 111 receives the off-track signal from the off-track signal generation unit 105, obtains the cycle of the off-track signal, and measures the track crossing speed of the beam spot on the basis of the cycle. When the track crossing speed enters into a predetermined range, the track crossing speed measurement unit 111 outputs a start signal to the measurement result integration unit 118, and thereafter, when the track crossing speed goes out of the predetermined range, it outputs an end signal to the integration unit 118. In FIG. 18, the start signal is outputted at the beginning of the off-track signal measurement period, and the end signal is outputted at the end of this period.

The measurement result integration unit 118 starts integration of the off-track signal high level periods and integration of the off-track signal low level periods on receipt of the start signal from the track crossing speed measurement unit 111, and ends the integration on receipt of the end signal. That is, the measurement result integration unit 118 performs integration during a period in which the track crossing speed is within a predetermined period. In the case of FIG. 18, it performs integration during the off-track signal measurement period.

The operation of the off-track level adjustment unit 110 for adjusting the off-track level on the basis of the ratio between the integrated high level period and the integrated low level period is identical to that described for the second embodiment, and therefore, repeated description is not necessary.

As described above, the optical disc device according to the sixth embodiment further includes the track crossing speed measurement unit 111 which measures the track crossing speed of the beam spot on the basis of the cycle of the off-track signal when performing an access accompanied with a jump over plural tracks due to tracking servo control or traverse servo control, and instructs the measurement result integration unit 118 of a period during which the track crossing speed is within a predetermined range, and the measurement result integration unit 118 performs integration during the period indicated by the track crossing speed measurement unit 111, whereby adjustment of the off-track level can be carried out in the stable off-track state, resulting in an increase in precision of adjustment.

The above-described adjustment of the off-track level may be carried out for every access accompanied with a track jump over plural tracks, or it may be carried out only once at a first access when the optical disc device is started. In the former case, the precision of the off-track level can be further improved. Further, although, in some optical discs, an appropriate off-track level at its inner circumference may differ from that at its outer circumference, the optical disc device according to the sixth embodiment can cope with such case.

1. An optical disc device comprising:
an optical pickup for applying laser light to an optical disc which is rotated by a disc motor, and receiving reflected light to generate a RF signal;
an envelope signal generation unit for generating an envelope signal on the basis of the RF signal;
an off-track signal generation unit for binarizing the envelope signal using an off-track level as a slice level to generate an off-track signal;
an off-track measurement unit for measuring high level periods and low level periods of the off-track signal; and
an off-track level adjustment unit for adjusting the off-track level which is set on the off-track signal generation unit, on the basis of the ratio between the high level periods of the off-track signal and the low level periods thereof.

2. An optical disc device as defined in claim 1 further comprising:
a measurement result integration unit for integrating the high level periods of the off-track signal and the low level periods thereof, respectively, which are measured by the off-track measurement unit; and
said off-track level adjustment unit performing adjustment of the off-track level on the basis of the ratio between the integrated high level period and the integrated low level period, which are obtained by the measurement result integration unit.

3. An optical disc device as defined in claim 2 further comprising:
a servo control unit for performing traverse servo control of the optical pickup, and tracking servo control in the optical pickup; and
said off-track level adjustment unit performing adjustment of the off-track level by using an off-track state which is generated by eccentricity of the optical disc or the disc motor in the state where the optical disc is rotated by the disc motor while the position of a beam spot of the laser light is fixed without performing traverse servo control and tracking servo control in the servo control unit.

4. An optical disc device as defined in claim 3 further comprising:
a rotation number measurement unit for measuring the number of rotations of the optical disc, and instructing the measurement result integration unit of a period during which the optical disc makes n rotations (n: integer equal to or larger than 1); and
said measurement result integration unit performing integration during the period instructed from the rotation number measurement unit.

5. An optical disc device as defined in claim 3 further comprising:
a measurement result selection unit for selecting high level periods and low level periods within a predetermined range, from among the high level periods and the low level periods of the off-track signal, which are measured by the off-track measurement unit, and outputting them to the measurement result integration unit; and
said measurement result integration unit integrating the high level periods of the off-track signal and the low level periods thereof, respectively, which are supplied from the measurement result selection unit.

6. The optical disc device as defined in claim 3 further comprising:
said disc motor outputting a 1/n rotation signal indicating that the optical disc has made 1/n rotation (n: integer equal to or larger than 2);
a track crossing number measurement unit for
measuring the number of track crossings in each of sector areas which are obtained by equally dividing the recording surface of the optical disc into n pieces of sectors, on the basis of the 1/n rotation signal and the off-track signal,
selecting a predetermined sector area on the basis of the number of track crossings in each sector area, and
instructing the measurement result integration unit of a period during which the beam spot exists in the selected sector area; and
said measurement result integration unit performing integration during the period instructed from the track crossing number measurement unit.

7. An optical disc device as defined in claim 2 further comprising:
a servo control unit for performing tracking servo control in the optical pickup; and
said off-track level adjustment unit performing adjustment of the off-track level when the beam spot of laser light crosses tracks under the tracking servo control.

8. An optical disc device as defined in claim 7 wherein
said off-track level adjustment unit performs adjustment of the off-track level when an access accompanied with a track jump over plural tracks (multi jump) is carried out under the tracking servo control.

9. An optical disc device as defined in claim 2 further comprising:
a servo control unit for performing traverse servo control of the optical pickup; and
said off-track level adjustment unit performing adjustment of the off-track level when the beam spot of laser light crosses tracks under the traverse servo control.

10. An optical disc device as defined in claim 9 wherein
said off-track level adjustment unit performs adjustment of the off-track level when the optical pickup is moved toward the inner circumference of the optical disc under the traverse servo control, at initial startup of the optical disc device.

11. An optical disc device as defined in claim 9 wherein
said servo control unit performs tracking servo control in the optical pickup; and
said off-track level adjustment unit performs adjustment of the off-track level when an access accompanied with a track jump over plural tracks (traverse seek) is carried out under the traverse servo control and the tracking servo control.

12. An optical disc device as defined in claim 8 or 11 further comprising:
a track crossing speed measurement unit for measuring the track crossing speed of the beam spot on the basis of the cycle of the off-track signal, and instructing the measurement result integration unit of a period during which the track crossing speed is within a predetermined range; and
said measurement result integration unit performing integration during the period instructed by the track crossing speed measurement unit.

13. An optical disc device as defined in claim 12 wherein
said off-track level adjustment unit performs adjustment of the off-track level while performing plural times of track jumps.
